(19) United States
(12) Patent Application Publication
(10) Pub. No.: US 2026/0227588 A1
(43) Pub. Date: Aug. 6, 2026

(54) CONFIGURING AN OPTICAL ASSEMBLY COMPRISING A PHOTONIC DEVICE AND AN OPTICAL COUPLING INTERFACE

(71) Applicant: Ciena Corporation, Hanover, MD (US)

(72) Inventors: Maxime Thibault-Maheu, Québec (CA); Lam Nguyen, Québec (CA)

(73) Assignee: Ciena Corporation, Hanover, MD (US)

(21) Appl. No.: 19/046,219

(22) Filed: Feb. 5, 2025

(51) Int. Cl. G02B 6/42

(52) U.S. Cl. CPC G02B 6/4271; G02B 6/4206

(57) ABSTRACT

In one aspect, in general, an apparatus comprises: a device carrier; a device carrier support attached to a first portion of the device carrier; a thermal control element in thermal contact with a second portion of the device carrier that is different than the first portion of the device carrier; a first photonic device comprising a port that is configured to emit or receive an optical wave; and an optical coupling interface; wherein the first photonic device is in thermal contact with at least a portion of the second portion of the device carrier; and wherein at least a portion of the optical wave is coupled between the optical coupling interface and the first photonic device.

### TECHNICAL FIELD

This disclosure relates to configuring an optical assembly comprising a photonic device and an optical coupling interface.

### BACKGROUND

Chip-scale devices and systems comprising integrated circuits (ICs) have applications ranging from electronics to optical connectivity. Increasing demand for integrated circuit systems has driven advancements in their operating capabilities, physical sizes, and reliability alongside optimization of associated manufacturing processes including production and testing. Some IC systems comprise electronic components configured to manipulate or transmit electric signals, while other IC systems comprise photonic structures or components configured to guide or manipulate electromagnetic waves. Some electromagnetic waves have a spectrum that has a peak wavelength that falls in a particular range of optical wavelengths (e.g., between about 100 nm to about 2 mm, or some subrange thereof), also referred to as optical waves, light waves, or simply light.

In some implementations, IC systems can comprise optical waveguiding structures configured to guide or manipulate electromagnetic waves that are in the optical wavelength region. Some integrated circuit systems comprise a mixture of electronic components and photonic components, leveraging the benefits of both technologies to enhance functionality and performance. Some IC systems can include multiple components within a single package, where each component performs specialized functions. For instance, some opto-electrical devices can comprise advanced configurations such as hybrid laser integration or optical amplifiers. These configurations can allow for greater device capabilities for advanced applications.

In some examples, optimizing device performance can be associated with thermal management of a device. Some examples of thermal management include thermal control elements, such as thermoelectric coolers (TECs) or passive heatsinks, that are configured to regulate operating temperatures. In some examples, management of thermal density given a physical footprint of a device can be associated with enhanced device performance, reliability, and decreased power consumption.

### SUMMARY

In one aspect, in general, an apparatus comprises: a device carrier; a device carrier support attached to a first portion of the device carrier; a thermal control element in thermal contact with a second portion of the device carrier that is different than the first portion of the device carrier; a first photonic device comprising a port that is configured to emit or receive an optical wave; and an optical coupling interface; wherein the first photonic device is in thermal contact with at least a portion of the second portion of the device carrier; and wherein at least a portion of the optical wave is coupled between the optical coupling interface and the first photonic device.

Aspects can include one or more of the following features.

The apparatus further comprises one or more optical components arranged on the device carrier, where at least one of the optical components is configured to focus, expand, collimate, or change a direction of propagation associated with at least a portion of the optical wave.

The apparatus further comprises a thermal interface material that is in thermal contact with the second portion of the device carrier and the thermal control element.

The thermal interface material comprises a thermally conductive gel.

The thermally conductive gel is deformable such that a stress associated with a coefficient of thermal expansion of the thermal control element is not induced on the device carrier.

The apparatus thermally conductive gel adheres to respective portions of the second portion of the device carrier and the thermal control element.

The device carrier support is attached to the first portion of the device carrier by an adhesive.

The apparatus further comprises a housing that encloses the device carrier, the thermal control element, and the first photonic device.

The housing comprises the optical coupling interface.

The housing comprises a portion of the device carrier support.

The housing comprises a package base that supports the thermal control element and the device carrier support.

The apparatus further comprises a second thermal control element in thermal contact with a third portion of the device carrier that is different from the first portion of the device carrier and the second portion of the device carrier; and a second photonic device in thermal contact with at least a portion of the third portion of the device carrier; wherein the second photonic device comprises a port that is configured to emit or receive an optical wave.

At least a portion of an optical wave is coupled between the second photonic device and the first photonic device.

The apparatus further comprises a second optical coupling interface; wherein at least a portion of the optical wave emitted by the second photonic device is coupled into the second optical coupling interface.

The thermal control element comprises a thermal electric cooler.

In another aspect, in general, a method of configuring an optical assembly comprising a first photonic device and an optical coupling interface comprises: attaching a first portion of a device carrier to a device carrier support; arranging a thermal control element to be in thermal contact with a second portion of the device carrier that is different than the first portion of the device carrier; and coupling at least a portion of an optical wave between a port of the first photonic device and the optical coupling interface; wherein the first photonic device is in thermal contact with at least a portion of the second portion of the device carrier.

Aspects can include one or more of the following features.

The method further comprises arranging a second thermal control element to be in thermal contact with a third portion of the device carrier that is different from the second portion of the device carrier and the second portion of the device carrier.

The optical assembly further comprises a second photonic device in thermal contact with at least a portion of the third portion of the device carrier.

The thermal contact between the second portion of the device carrier and the thermal control element comprises a thermal interface material.

The thermal interface material comprises a thermally conductive gel that is deformable such that a stress associated with a coefficient of thermal expansion of the thermal control element is not induced on the device carrier.

Aspects can have one or more of the following advantages.

Without using the method disclosed herein, some thermal management systems can be configured such that a thermal control element has a physical footprint that is similar to that of optical components. In contrast, using the methods disclosed herein, the size of a thermal control element can be reduced and the thermal control element can be localized to a particular portion of a device carrier. In some examples, using a smaller thermal control element can be associated with a reduction in device cost and/or power consumption. In some examples, using a smaller thermal control element can be associated with an increase in performance or device stability.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example optical assembly.

FIG. 2 is a schematic diagram of an example optical assembly comprising a housing.

FIG. 3 is a schematic diagram of an example optical assembly.

FIGS. 4A-4B are schematic diagrams of an example optical assembly comprising multiple thermal control elements.

### DETAILED DESCRIPTION

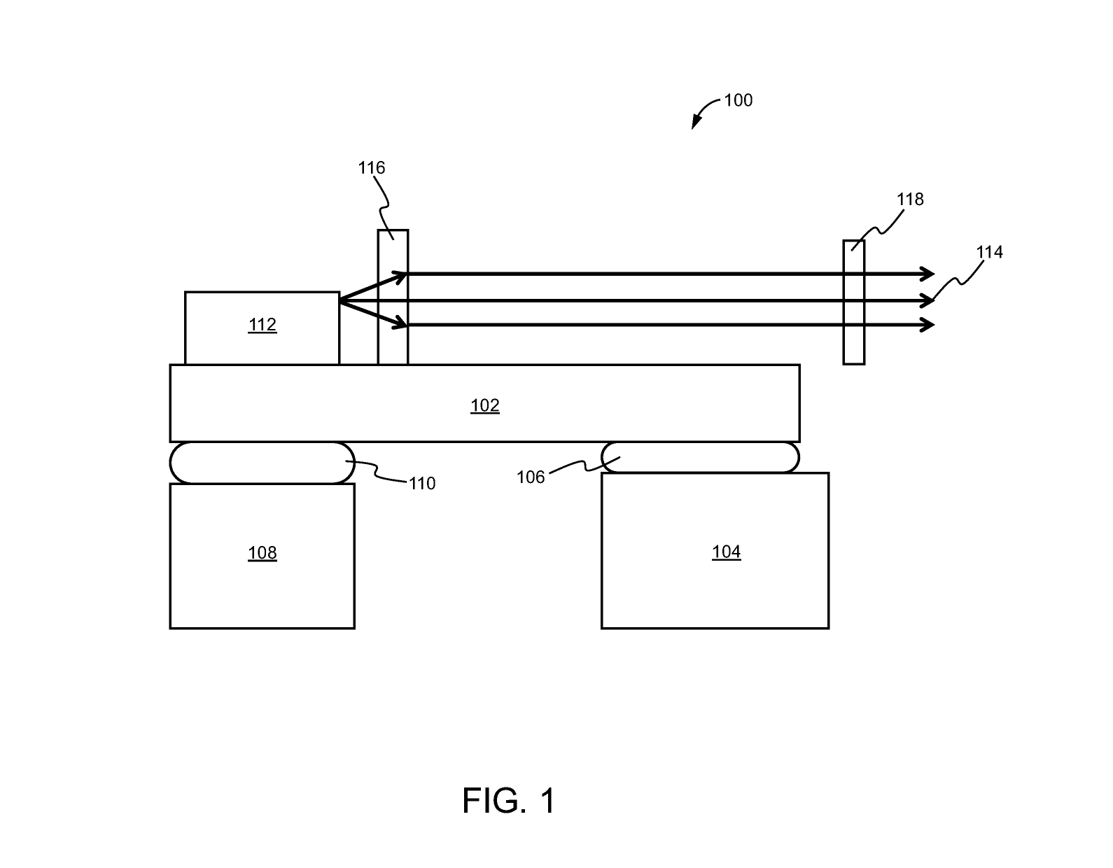

FIG. 1 depicts a side view of an example optical assembly 100. The optical assembly 100 comprises a device carrier 102 and a device carrier support 104 attached to a first portion of the device carrier 102. In this example, the device carrier support 104 is attached to the first portion of the device carrier 102 by an adhesive 106. The optical assembly 100 further comprises a thermal control element 108 that is in thermal contact with a second portion of the device carrier 102 that is different than the first portion. In this example, the thermal control element 108 is in thermal contact with the second portion of the device carrier 102 via a thermal interface material (TIM) 110 that conducts heat between solid mating surfaces of the device carrier 102 and the thermal control element 108. The optical assembly 100 further comprises a photonic device 112 comprising a port that is configured to emit or receive an optical wave. In this example, the port emits the optical wave 114. The photonic device 112 is in thermal contact with at least a portion of the second portion of the device carrier 102. The optical wave 114 interacts with an optical component 116. In this example, the optical component 116 collimates the optical wave 114, which propagates and is coupled into an optical coupling interface 118. In other words, the optical wave 114 is coupled between the optical coupling interface 118 and the photonic device 112. In this example, the optical coupling interface 118 comprises an optical window.

In some examples, securing a device carrier to a device carrier support can result in a “floating interface” between a thermal control element and the device carrier. This floating interface is associated with the use of the TIM between the device carrier and the thermal control element, rather than an adhesive. The TIM can be compliant or gel-like such that mechanical disturbances are not transferred to the device carrier and optical components supported by the device carrier. In this way, the thermal control element does not totally support the device carrier or optical components mounted thereon. This configuration can avoid deleterious effects associated with the mechanical disturbances on the optical alignment and coupling into the optical window. For instance, the device carrier can be isolated from an expansion associated with the thermal control element that can induce optical misalignment.

Without using the methods disclosed herein, some optical assemblies can comprise a thermal control element with a large physical footprint that supports each of a photonic device and one or more optical components. In some examples, using a larger thermal control element for a small heat load can induce excessive resistivity loss and be associated with a poor coefficient of performance. In contrast, using the methods disclosed herein, the physical footprint of a thermal control element can be reduced to match the physical footprint of the photonic device such that the thermal control element locally controls the temperature of a portion of the device carrier. In some examples, this reduction in size can be associated with a reduction in cost and electrical power consumption. In addition, the reduction in size can be associated with a reduction in optical misalignment caused by thermal expansion of components supporting the photonic device.

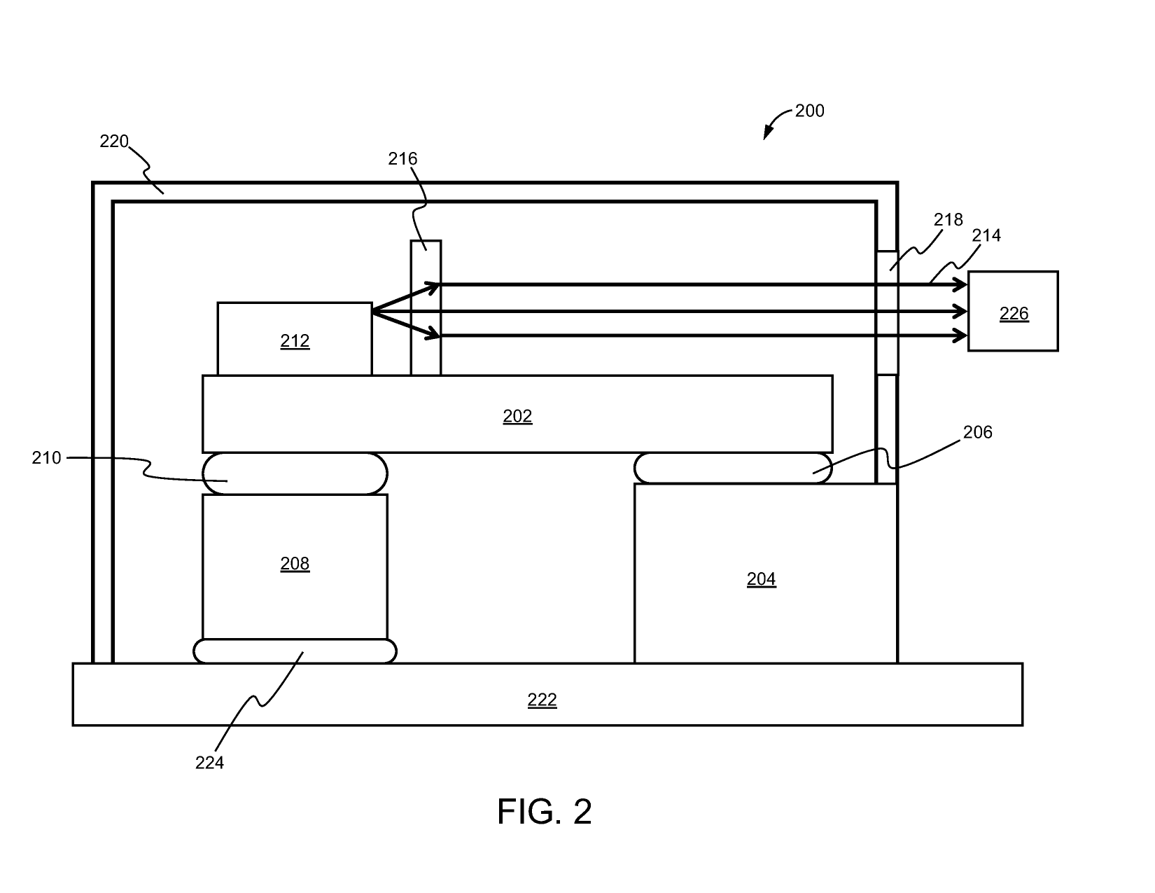

Some optical assemblies or systems can comprise a housing that encloses the device carrier, thermal control element, and the photonic device. FIG. 2 depicts a side view of an example optical assembly 200. The optical assembly 200 comprises a device carrier 202 comprising a first portion that is attached to a device carrier support 204 by adhesive 206. A thermal control element 208 is in thermal contact via thermal interface material 210 with a second portion of the device carrier 202 that is different from the first portion. A photonic device 212 emitting optical wave 214 is in thermal contact with the second portion of the device carrier 202. An optical component 216 collimates the optical wave 214, which is coupled into an optical coupling interface 218. In this example, the optical coupling interface 218 comprises an optical window. The optical assembly 200 further encloses a housing 220 enclosing the device carrier 202, the thermal control element 208, and the photonic device 212. In this implementation, the housing 220 comprises the optical coupling interface 218, as well as a portion of the device carrier support 204. A package base 222 supports the thermal control element 208 and the device carrier support 204. In the example optical assembly 200, the package base 222 is attached to the thermal control element 208 by adhesive 224. Following the optical coupling interface 218, the optical wave 214 is coupled into an external fiber 226.

Some optical assemblies can optimize the coupling between an optical wave and an optical coupling interface. Some coupling optimizations can comprise maximizing an output power associated with an optical wave coupled from the photonic device to the optical coupling interface. In some examples, optimization can comprise minimizing a difference between a height of the optical coupling interface relative to the device carrier support and a height of the output port of the photonic device relative to the device carrier support. In some implementations, material properties, such as a coefficient of thermal expansion (CTE), associated with an adhesive between the device carrier and device carrier support can be used to control these heights. Some adhesives can comprise fillers that are added to vary the CTE associated with the adhesive.

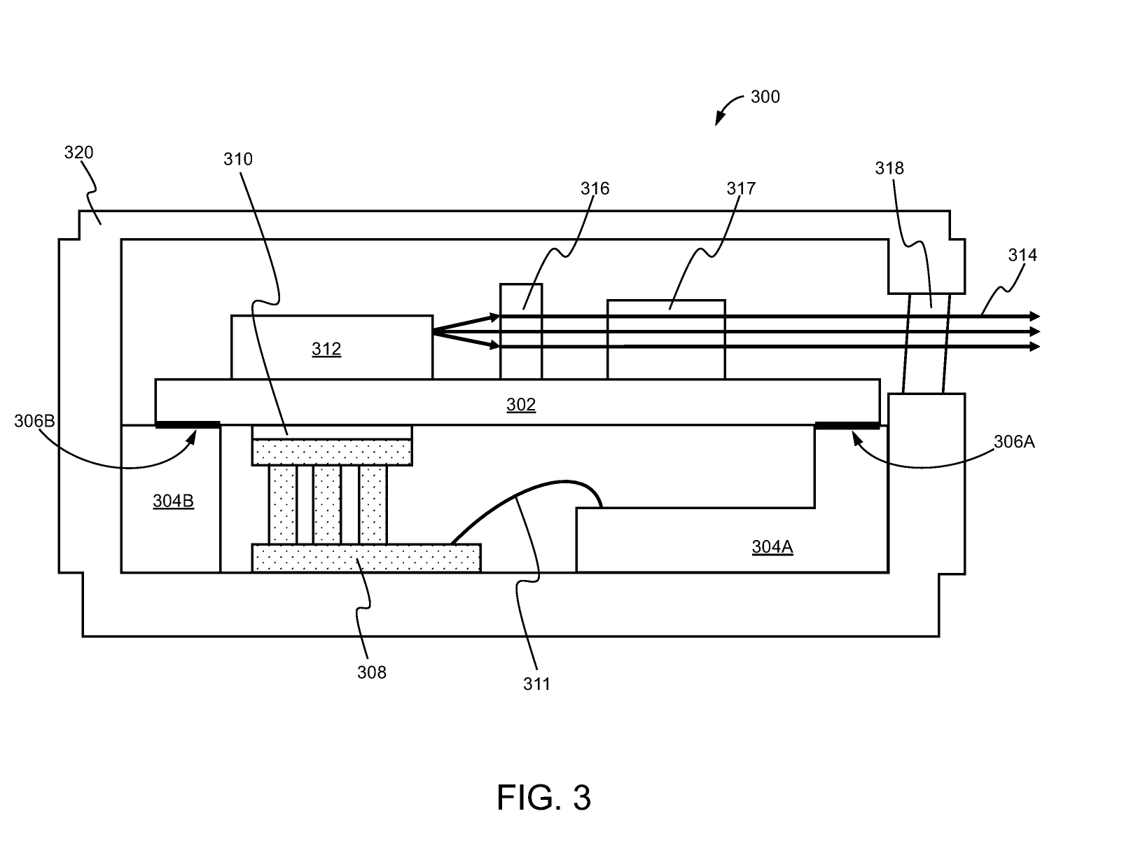

In some implementations, a housing can enclose a device carrier support such that the housing does not comprise a portion of the device carrier support. Some housings can also provide a hermetic seal to prevent an optical assembly from exposure to environmental factors such as humidity, dust, and temperature fluctuations. FIG. 3 depicts a side view of an example optical assembly 300. The optical assembly 300 comprises a device carrier 302 attached to a first device carrier support 304A by adhesive 306A. The device carrier 302 is also attached to a second device carrier support 304B by adhesive 306B. A thermal control element 308 is in thermal contact with the device carrier 302 through thermal interface material 310. In this example, the thermal control element 308 comprises a thermal electric cooler that is in electrical communication with the first device carrier support 304A by interface 311, e.g., a wire. A photonic device 312 is arranged on the device carrier 302 such that the photonic device 312 is in thermal contact with the thermal control element 308. The photonic device 312 emits, from an output port, optical wave 314. The optical wave 314 passes through a first optical component 316, e.g., a collimating lens, and a second optical component 317, e.g., an optical isolator. The optical wave 314 is coupled into optical coupling interface 318. A housing 320 encloses the device carrier 302, the first device carrier support 304A, the second device carrier support 304B, the thermal control element 308, and the photonic device 312. In some implementations, the housing 320 can be configured to provide a hermetic seal such that the components housed within are protected from external environmental conditions. In some examples, each of the first device carrier support 304A, the second device carrier support 304B, and the thermal control element 308 can be secured to the housing by adhesive (not shown).

Referring back to FIG. 2, in some optical assemblies, optical waves can be coupled into an external optics such as fiber optics. In some implementations, fiber optic components can be integrated into a housing such that the hermiticity is maintained. For instance, in some optical assemblies, an optical coupling interface can comprise a hermetic fiber ferrule or a lensed fiber optic. Materials such as solder can also be used to fill in a fiber entrance cavity of an optical assembly to maintain hermeticity.

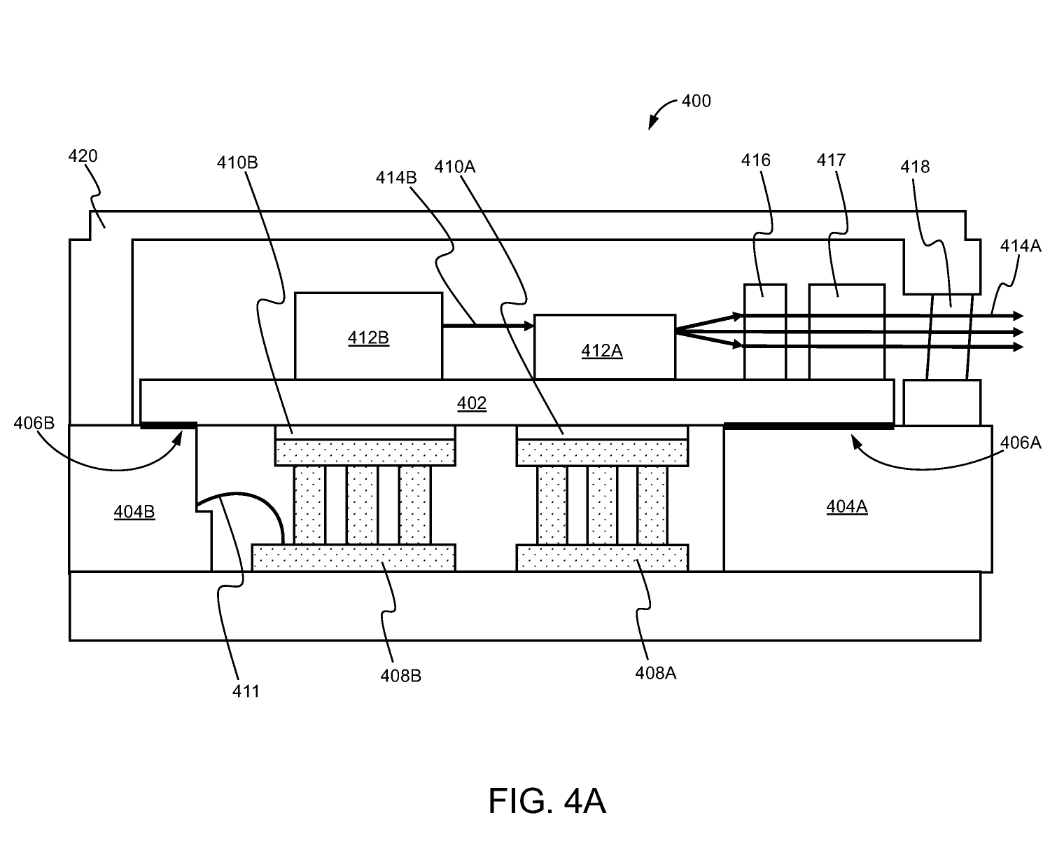

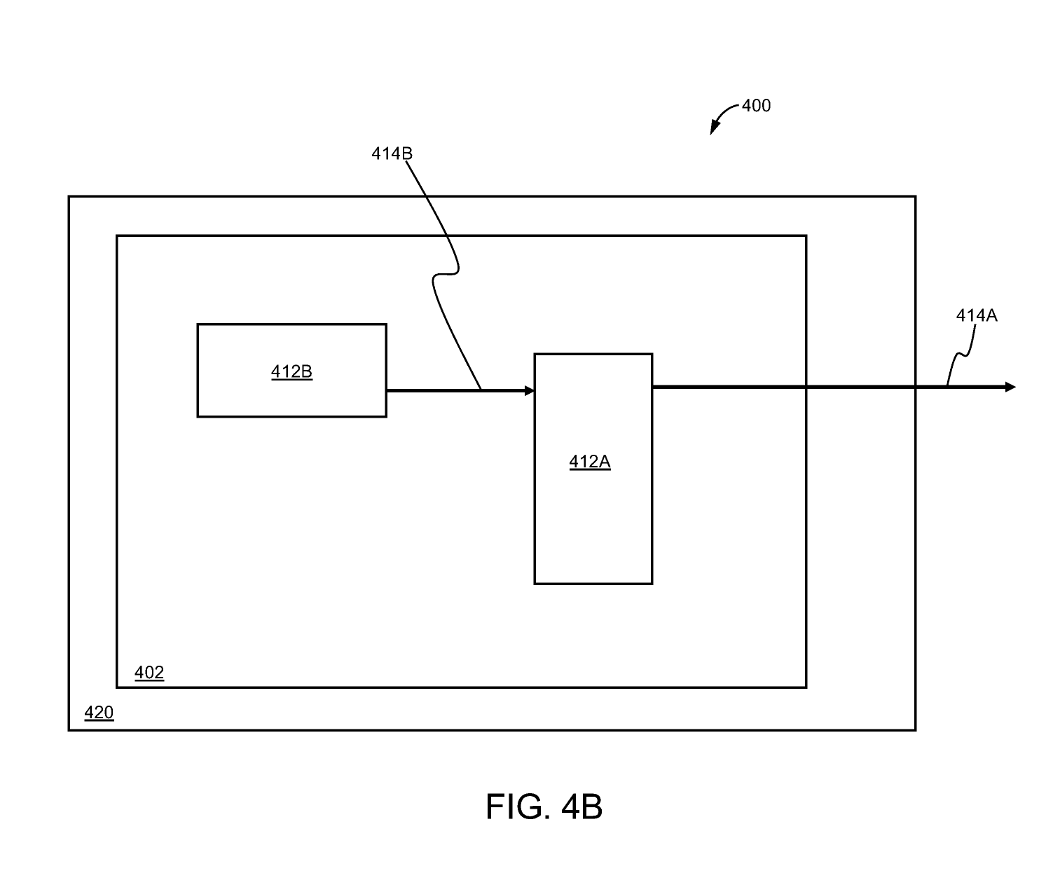

Some devices can comprise multiple thermal control elements that each control respective portions of a device carrier. FIG. 4A depicts a side view of an example optical assembly 400 and FIG. 4B depicts a top view of the example optical assembly 400. The optical assembly 400 comprises a device carrier 402 attached to a first device carrier support 404A and a second device carrier support 404B by adhesives 406A, 406B, respectively. A first thermal control element 408A, e.g., a thermal electric cooler, is in thermal contact with a first portion of the device carrier 402 via thermal interface material 410A. A first photonic device 412A is arranged on the device carrier 402 such that the first photonic device 412A is in thermal contact with the first portion of the device carrier 402. The first photonic device 412A emits optical wave 414A from an output port. The optical wave 414A passes through a first optical component 416, e.g., a collimating lens, and a second optical component 417, e.g., an optical isolator, before being coupled into an optical coupling interface 418. The optical assembly 400 further comprises a second thermal control element 408B, e.g., a thermal electric cooler, that is in thermal contact with a second portion of the device carrier 402 via thermal interface material 410B. A second photonic device 412B is in thermal contact with the second portion of the device carrier 402. The second photonic device 412B emits optical wave 414B that is coupled into the first photonic device 412A. The optical assembly 400 further comprises a housing 420 that comprises a portion of the first device carrier support 404A and the second device carrier support 404B. In this example, each of the first thermal control element 408A and the second thermal control element 408B can independently control a temperature associated a different respective portion or zone of the device carrier 402. By way of example, the first photonic device 412A could be maintained at a first temperature, e.g., 50⁰C, while the second photonic device 412B could be maintained at a second temperature, e.g., 60⁰C. While the optical assembly 400 comprises two photonic devices, some optical assemblies can comprise more than two photonic devices, where each photonic device is in thermal contact with a different respective thermal control element.

The first photonic device 412A depicted in FIGS. 4A-4B is configured to receive an optical wave and emit and optical wave while the second photonic device 412B is configured to emit optical waves. In some examples, the first photonic device 412A can be configured to receive an optical wave from the optical coupling interface 418 such that the optical wave is coupled between the optical coupling interface 418 and the first photonic device 412A. In some examples, the second photonic device 412B can receive an optical wave from the first photonic device 412A such that the optical wave is coupled between the first photonic device 412A and the second photonic device 412B.

In some implementations, a portion of a respective optical wave can be coupled between each photonic device of a plurality of photonic devices and a different respective optical coupling interface. For instance, a portion of an optical wave emitted by a first photonic device can be coupled into a first optical coupling interface while a portion of an optical wave emitted by a second photonic device can be coupled into a second optical coupling interface. In some examples, each of these photonic devices emit different respective wavelengths such that the first optical coupling interface and the second optical coupling interface can be optimized for the different respective wavelengths. Each photonic device of the plurality of photonic devices can also be associated with different respective sets of one or more optical components that can manipulate a respective optical wave emitted by a respective photonic device.

As shown in FIGS. 1-4, some photonic devices can be configured to emit an optical wave. In some implementations, a photonic device can be configured to receive an optical wave, for instance an optical wave provided by an external source. In such implementations, a portion of an optical wave can be coupled between an optical coupling interface and a photonic device in a reverse manner than the examples depicted in FIGS. 1-4.

Some optical coupling interfaces can comprise an optical window, a fiber, fiber optic components, or another photonic integrated circuit.

In some examples, a system can comprise multiple optical components arranged on the device carrier, where each optical component is configured to affect some characteristic of the optical wave. For example, each optical component (or two or more of the optical components in combination) can be configured to focus, expand, or change a direction of propagation associated with at least a portion of the optical wave emitted from the photonic device. In some examples, these multiple optical components can be referred to as an “optical train.” Some optical components can be transmissive while some optical components can be reflective. Examples of optical components include, but are not limited to, lenses, beamsplitter, modulators, fiber-optical components, isolators, or mirrors. Some mirrors or lenses can comprise concave or convex shapes to focus or expand an optical wave. In some examples, one or more of the optical components can be attached to a device carrier using adhesives, solder-based connections, or laser welding. Some solder-based connections can be formed with alloys comprising elements such as tin, silver, copper, lead, or some combination thereof. Some alloys can be associated with a low melting temperature such that heat damage to components can be mitigated. In some examples, laser welding can be performed on optical components having a metallization layer. In some implementations, a photonic device can also be attached to a device carrier by thermally-conductive adhesives, conductive structures, and underfill materials. Some conductive structures can be formed from solder bumps or solder pads such that flip-chip assembly techniques can be utilized.

In some implementations, each of one or more of the photonic devices can be in electrical communication with components such as radiofrequency (RF) controllers.

Some photonic devices can comprise materials such as silicon, gallium arsenide, indium phosphide, lithium niobate, or barium titanate. Some photonic devices can comprise hybrid integration of these materials, for instance, silicon and thin-film lithium niobate.

In some implementations, a device carrier can comprise an optical bench. Some optical benches can comprise materials such as silicon, silicon carbide, aluminum nitride, aluminum oxide, or glass.

In some implementations, a device carrier support can comprise materials such as ceramics. Such implementations of a device carrier support can be referred to as a “ceramic shelf.” Some device carrier supports can be formed from organic, glass, or metal substrates. Some organic substrates can comprise high-density build-up (HDBU) substrates or substrate-like printed circuit board (SLP) substrates. Some glass substrates can comprise materials such as borosilicate or quartz. Some metal substrates can comprise materials or alloys that are associated with a low CTE, such as iron nickel cobalt (FeNiCo) or tungsten copper (CuW).

Some thermal interface materials can comprise a thermally conductive gel or gap filler that can conform to intricate topographies or complex surface features. Some thermal interface materials can be deformable such that a stress associated with a coefficient of thermal expansion of a thermal control element is not induced on a device carrier support. Alternatively, some thermal interface materials can deflect easily under low compressive forces to decrease stress on a device carrier and components supported by the device carrier. Some thermal interface materials can adhere to a respective portion of a device carrier or a thermal control element. Some thermal interface materials comprise polymers, resins, crosslinking agents, or curing agents. Some thermal interface materials comprise a paste-like or grease-like consistency.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a device carrier;
a device carrier support attached to a first portion of the device carrier;
a thermal control element in thermal contact with a second portion of the device carrier that is different than the first portion of the device carrier;
a first photonic device comprising a port that is configured to emit or receive an optical wave; and
an optical coupling interface;
wherein the first photonic device is in thermal contact with at least a portion of the second portion of the device carrier; and
wherein at least a portion of the optical wave is coupled between the optical coupling interface and the first photonic device.

2. The apparatus of claim 1, further comprising one or more optical components arranged on the device carrier, where at least one of the optical components is configured to focus, expand, collimate, or change a direction of propagation associated with at least a portion of the optical wave.

3. The apparatus of claim 1, further comprising a thermal interface material that is in thermal contact with the second portion of the device carrier and the thermal control element.

4. The apparatus of claim 3, wherein the thermal interface material comprises a thermally conductive gel.

5. The apparatus of claim 4, wherein the thermally conductive gel is deformable such that a stress associated with a coefficient of thermal expansion of the thermal control element is not induced on the device carrier.

6. The apparatus of claim 5, wherein the thermally conductive gel adheres to respective portions of the second portion of the device carrier and the thermal control element.

7. The apparatus of claim 1, wherein the device carrier support is attached to the first portion of the device carrier by an adhesive.

8. The apparatus of claim 1, further comprising a housing that encloses the device carrier, the thermal control element, and the first photonic device.

9. The apparatus of claim 8, wherein the housing comprises the optical coupling interface.

10. The apparatus of claim 8, wherein the housing comprises a portion of the device carrier support.

11. The apparatus of claim 8, wherein the housing comprises a package base that supports the thermal control element and the device carrier support.

12. The apparatus of claim 1, further comprising
a second thermal control element in thermal contact with a third portion of the device carrier that is different from the first portion of the device carrier and the second portion of the device carrier; and
a second photonic device in thermal contact with at least a portion of the third portion of the device carrier;
wherein the second photonic device comprises a port that is configured to emit or receive an optical wave.

13. The apparatus of claim 12, wherein at least a portion of an optical wave is coupled between the second photonic device and the first photonic device.

14. The apparatus of claim 13, further comprising
a second optical coupling interface;
wherein at least a portion of the optical wave emitted by the second photonic device is coupled into the second optical coupling interface.

15. The apparatus of claim 1, wherein the thermal control element comprises a thermal electric cooler.

16. A method of configuring an optical assembly comprising a first photonic device and an optical coupling interface, the method comprising:
attaching a first portion of a device carrier to a device carrier support;
arranging a thermal control element to be in thermal contact with a second portion of the device carrier that is different than the first portion of the device carrier; and
coupling at least a portion of an optical wave between a port of the first photonic device and the optical coupling interface;
wherein the first photonic device is in thermal contact with at least a portion of the second portion of the device carrier.

17. The method of claim 16, further comprising arranging a second thermal control element to be in thermal contact with a third portion of the device carrier that is different from the second portion of the device carrier and the second portion of the device carrier.

18. The method of claim 17, wherein the optical assembly further comprises a second photonic device in thermal contact with at least a portion of the third portion of the device carrier.

19. The method of claim 16, wherein the thermal contact between the second portion of the device carrier and the thermal control element comprises a thermal interface material.

20. The method of claim 19, wherein the thermal interface material comprises a thermally conductive gel that is deformable such that a stress associated with a coefficient of thermal expansion of the thermal control element is not induced on the device carrier.
